(19) United States
(12) Patent Application Publication
(10) Pub. No.: US 2017/0252839 A1
(43) Pub. Date: Sep. 7, 2017

(54) Side Milling Cutter and Production Method

(71) Applicant: Rosswag GmbH, Pfinztal (DE)

(72) Inventors: Sven Donisi, Pfinztal (DE); Gregor Graf, Pfinztal (DE)

(21) Appl. No.: 15/505,933

(22) PCT Filed: Aug. 27, 2015
(86) PCT No.: PCT/EP2015/001745

§ 371 Date: Feb. 23, 2017

(30) Foreign Application Priority Data
Aug. 27, 2014 (DE) 10 2014 012 481.9

(51) Int. Cl. B23C 5/28; B23C 5/08; B23C 5/00

(52) U.S. Cl. CPC B23C 5/28; B23C 5/006; B23C 5/08; B23C 5/02

(57) ABSTRACT

The invention relates to a side milling cutter (1) which comprises a disk body (11) with a central hub (12) for accommodation in a milling drive, and a plurality of cutters (21) which are arranged on the outer periphery thereof. A plurality of inner cooling lubricant channels (3) extend in the disk body (11), said channels having two or more outlet openings (31) in the area of each cutter (21). Said outlet openings (31) are oriented such that a cooling lubricant jet (K) which exits from the cooling lubricant channel (3) can be directed to the cutter (21). The invention also relates to a production method for the side milling cutter (1).

The following invention relates to a side milling cutter and to a method for producing same.

In the machining of workpieces, the cutting tools are cooled in order to prevent overheating and thus premature wearing of the cutting lips. The cooling lubricants used for this purpose consist primarily of water and contain particular additives, for instance for lubrication, changing the wetting properties and/or antifoam agents. Early systems worked with large volume flows and a locally comparatively undefined cooling lubricant output, for instance via flexible hoses which were guided up to the cutting tool.

This type of cooling, also known as flood cooling, has the drawback that the consumption of cooling lubricant is very high and the cooling is not very effective, since the location of heat development, namely the cutting lip itself, is supplied with cooling lubricant only unsatisfactorily; chips that fly off and/or settle on the cutting tool can in this case deflect the cooling lubricant jet and thus impair the cooling of the cutting lip. During the milling of very narrow and/or deep grooves by means of side milling cutters, it is even possible for the feed Of cooling lubricant to the cutting lip to virtually come to a stop, since the milling tool itself blocks the feed.

In order to solve a similar problem in turning, cutting tool holders are known for example, which have internal cooling passages, which make it possible to deliver cooling lubricant under high pressure directly to the cutting tool, for instance from DE 20 2012 004 900. U1 and WO 2013 132480 A1.

Also known are internally cooling end milling cutters, for instance an internally cooled solid carbide cutter for stainless steel, which has two helically twisted cooling lubricant passages on the inside.

Although relatively short and deep grooves, for example for receiving feather keys, can be produced with this end milling cutter, it is unsuitable for creating long grooves, bearing seats and similar geometries at high cutting rates. For this purpose, use is still made of side milling cutters which have a greatly limited maximum cutting rate even when use is made of cutting inserts made of carbide. Conventional flood cooling is generally used for cooling the side milling cutters.

Proceeding from this prior art, the present invention is based on the object of creating an improved side milling cutter which is distinguished by a higher achievable cutting rate and an increased service life of the cutting lips.

This object is achieved by a side milling cutter having the features of independent claim 1.

Furthermore, the object of creating a method for producing the side milling cutter arises, with which said side milling cutter is able to be produced cost-effectively in few work steps.

This object is achieved by a production method having the features of claim 12.

Preferred exemplary embodiments of the device and of the method are described by the respective dependent claims.

The generatively produced side milling cutter according to the invention has a disk body with a central hub to be received in a milling drive and a plurality of cutting lips on its outer circumference. A plurality of internal cooling lubricant passages extend in the disk body, said cooling lubricant passages having two or more outlet openings in the region of each cutting lip. The outlet openings are oriented such that in each case one cooling lubricant jet, which emerges from the cooling lubricant passage, can be directed onto the cutting lip. In this case, the hub can advantageously be formed in one piece with the disk body. Advantageously, the hub has a greater material thickness than the disk body, in order to allow secure coupling for torque introduction with the milling drive. The fact that “two or more outlet openings are present on each cutting lip” covers the solution in which two at least partially separate cooling lubricant passages extend to the cutting lip. Provision can in particular be made for the cooling lubricant jets to strike the cutting lip at different points.

“Generative production”, which, in contrast to cutting or casting production methods, is also referred to as additive manufacturing, includes powder bed methods (e.g. selective laser melting, electron beam melting) and build-up methods or free-space methods (e.g. build-up welding). Such a complex geometry as the side milling cutter according to the invention has would not be producible with conventional production techniques (metal-cutting production, in particular deep drilling).

A “cutting lip” is understood here to be the sharp edge of a tool at which machining takes place. The term includes in this case the variants in which said cutting lip is integrated into the disk body or is exchangeable, in particular as a cutting insert which can consist for example of carbide, diamond or ceramic. With regard to the outlet opening, “in the region” means that it is present at a distance from the cutting lip, said distance still just allowing “spraying” of the cutting lip to be achieved at a given pressure of the cooling lubricant.

The outlet openings arranged in the region of the cutting lip are intended to direct a cooling lubricant jet directly onto the cutting lip, this not only contributing toward improving the transporting away of chips but also toward keeping the cutting-chip body cooler, this also counteracting the thermal expansion of the disk body and thus benefiting accuracy of production. In addition, as a result of a feed of the cooling lubricant at high pressure onto the tool cutting lip, chip breaking can be supported and a lower chip volume ratio can be achieved.

In a further embodiment, the two outlet openings can be configured to direct the cooling lubricant jets onto the cutting lip with a predetermined angular offset, in order to support the transporting away of chips and to cool the disk body.

The direction in which the cooling lubricant jet emerges from the outlet opening is in this case determined substantially by the orientation of the passage axis. The two cooling lubricant jets fulfill different functions, wherein one of the cooling lubricant jets is provided to cool the cutting lip and to support chip breaking and the other conveys the chips out of the milled groove.

It is also possible for the outlet openings to be configured to direct in each case one cooling lubricant jet onto the cutting lip from different sides or from opposite directions.

Furthermore, during operation, it is possible for at least one of the cooling lubricant jets to be directed at a chip detachment zone of the cutting lip. The “chip detachment zone” is the region of the cutting lip in which the chip breaks, i.e. the cooling lubricant jet is advantageously directed exactly at the “gap” between the cutting lip and the chips that are detached during operation.

Furthermore, at least one of the outlet openings can have a nozzle which can be inserted for example into the outlet opening. The nozzle can be an angularly adjustable nozzle, for which the outlet angle can be set individually, depending for instance on the material to be machined, the cutting rate, etc. The nozzle forms a constriction of the cooling lubricant passage, increasing the outlet rate of the cooling lubricant and as a result supporting the chip forming process.

The disk body of the generatively produced side milling cutter according to the invention can have a thickness in the range from 1 mm to 20 mm, preferably in a range from 2 mm to 12 mm.

These small thicknesses are not producible with conventional production techniques (in this case deep drilling of the cooling lubricant passages), since there is the risk of the disk body being structurally weakened by the internal cooling lubricant passages, with the result that it fails under the action of the cutting forces.

In a further embodiment, the internal cooling lubricant passages can extend in a star-shaped manner away from the hub and/or emerge from a lateral face of the disk body. Alternatively or additionally, it is possible for the cooling lubricant passages to emerge obliquely from the surface of the disk body and/or to have one or more deviations which is/are preferably present in an end portion arranged close to the outlet openings. The deviation or deviations can in this case also be rounded and/or curved.

“Oblique” means that the cooling lubricant passage does not emerge normally to the surface (to be more precise, to a tangential plane at the surface). “Star-shaped” means substantially radially with respect to the individual passage, but a course of passages is also included which deviates slightly from the radial course. Since a side milling cutter has the cutting lips on its lateral face, it is expedient for homogeneous cooling for the outlet openings to be provided precisely at the lateral face; however, it is not precluded for the outlet openings to be provided at an end face of the disk body, wherein the passages can in this case emerge for example at a very shallow angle. The cooling lubricant passage does not in this case have to extend along the shortest connection between the feed opening and the outlet opening, but its course can also be adapted with regard to a particular minimum rigidity to be achieved of the disk body. A passage which does not extend in a straight manner can also be necessary, however, when bores or the like “block” the direct path; the cooling lubricant passage can in this case also have one or more deviations which can advantageously be rounded. As a result of the rounding of the deviations, a lower pressure drop is achieved, this contributing toward an energy-saving mode of operation.

In yet another embodiment, the cooling lubricant passages can emerge at an inner face of the hub or at a disk face and each have a feed opening for cooling lubricant there, said feed opening being fluidically connectable to a cooling lubricant source. The cooling lubricant passages then each extend from the feed opening to the outlet opening. The “inner face” of the hub means the inner lateral face with which the hub is plugged onto the milling drive. In this case, a feed of the cooling lubricant can take place conveniently via the hub, which is rotationally fixed with regard to the milling drive; sealing is no problem in this case, since sealing only takes place at a standstill, wherein standard sealing elements can be used.

“Disk face” in this case means the end face of the disk, wherein emergence of the passages in this region advantageously makes it possible to use a flanged-on adapter-like ring structure with internal feed passages, wherein the cooling lubricant feed can take place via previous outlet openings of the main body.

According to one development, an encircling groove can be present on the inner face of the hub, the cooling lubricant passages leading into said groove. In this case, the encircling groove forms a sealable coupling portion for fluidically connecting to the cooling lubricant source. It would also be possible to say that the sealable groove acts as a collecting channel from which all the cooling lubricant passages are supplied; the feed openings assigned to the individual cooling lubricant passages are thus located at the bottom of the groove.

The cutting lips can each be formed by exchangeable cutting inserts which are each received in an associated cutting insert seat on the outer circumference of the disk body. Such receiving systems of cutting inserts are known, wherein the basic principle is that of making machining more economical by replacing only the actual cutting-lip body in the event of wear and continuing to use the disk body as a “structural body”.

Such cutting insert seats are often slotted, wherein the slot extends away from the cutting insert seat. In this case, a substantially radial extent inward is suitable. The slot serves to “weaken” the volume, adjoining the slot, of the holder body, in order to be able to elastically deform it more easily. Under the action of a clamping device, for instance a clamping screw, which is screwed in normally to the slot in the holder body, the slot is narrowed and thus makes it possible to clamp the cutting insert firmly in the cutting insert seat. The slot can have a rounding at its end remote from the cutting insert seat, it being possible for said rounding to be formed for example by a bore that extends parallel to the slot plane; this additionally reduces the notch effect of the slot end.

One or more of the cooling lubricant passages can alternatively or additionally have a noncircular cross section, for instance a rectangular cross section. A cross section which has a width/height ratio of 1:2 or more is suitable, for instance.

Via rectangular passage cross sections, a comparatively large area through which flow takes place can be realized even in the case of an extremely flat disk body, whereas, in the case Of invariably round bores, the area through which flow takes place correlates directly with the thickness of the holder body. The passage cross section can also be rounded or in particular oval. A triangular or arcuate passage cross section is likewise possible, which allows an improved structure as a result of the higher supporting effect of the overhang during generative production.

The method according to the invention for producing the side milling cutter is carried out using a generative production device. It comprises the following steps of:

a) loading a 3D volume data set, which describes at least the disk body with the central hub of the side milling cutter, into the generative production device,
b) providing a pulverulent starting material,
c) progressively producing material cohesion of the pulverulent starting material, in the process progressively producing the disk body with the plurality of internal cooling lubricant passages, which have at least two outlet openings in the region of each cutting lip, and the central hub.

Via generative production methods which, in contrast to cutting or casting production methods, are also referred to as additive manufacturing methods, it is possible to produce even very complicated geometries with undercuts, hidden inner parts or the like, which would not be producible by casting and/or machining.

Such a component which is not producible with conventional production techniques or is only producible therewith with a great deal of effort is also the side milling cutter according to the invention: A plurality of cooling lubricant passages which emerge from the surface in the region of the circumferentially arranged cutting lips and extend from a central feed on the inner face of the hub would not be producible in the diameter ranges with conventional drilling techniques, since the disk body is often less than 2 mm thick. The lengths to be drilled also often exceed economically achievable diameter/length ratios in disk bodies with large diameters.

Using generative production techniques, it is possible to produce as many cooling lubricant passages as desired with virtually as many outlet openings as desired, without additional costs; in this case, it is even possible to provide internal passage branches which can be designed optimally in terms of flow. The passage length is also no longer limited; thus, any desired diameter/length ratios can be achieved, which would be achievable only using extremely expensive deep drilling techniques when conventional drilling techniques are used.

It is even conceivable to realize a nonround passage cross section, for instance square or rectangular; as a result, a comparatively large cross-sectional area through which flow takes place can be achieved even in extremely thin disk bodies, whereas the cross section through which flow takes place in known solutions would be limited directly by the thickness of the disk body.

The “3D volume data set” means here a CAD volume model of the holder body, which describes not only the envelope surface but the volume as it were as a “voxel”. The volume data can also be generated only in the generative production device, wherein the 3D data are provided for instance as a surface model in. STL format and fully enclosed surface features are interpreted as volume by the generative production device. In order to obtain a solid body, first of all the material cohesion of predetermined points is established in a plane and then continued plane by plane.

As a result, the component can be produced as it were in one step, with little reworking effort or even without reworking and with high accuracy. In order to establish the material cohesion, the pulverulent starting material can be fully melted, or the material cohesion is created beforehand by partial melting of the powder particles. Alternatively, it is also possible here to establish a preliminary material cohesion by using low-melting components. In a subsequent sintering operation, complete fusing of the powder particles is then established by a melting operation and any additional components are expelled.

The pulverulent starting material can be in particular a metal powder. The generative production device can be a device for selective laser melting, selective laser sintering or laser build-up welding. The abovementioned production devices are only examples, however; the production method according to the invention can also be carried out using other generative production devices, which use for example electron beams or other high-energy radiation as energy source.

Finally, when the production method is carried out, a step of internally smoothing the cooling lubricant passages, for instance flow grinding, can be carried out. This step is suitably carried out after completion of the component, but can in principle also be carried out at any other time. Flow grinding is understood to be the repeated pumping through of an abrasive solution admixed with abrasive particles, wherein the surface roughness can be effectively reduced thereby, this contributing, inter alia, toward less flow resistance and a smaller pressure drop during throughflow. The desired formation of laminar flows in the passages can be the result here. In particular, functional edges such as forks in the “network” of cooling lubricant passages can be effectively smoothed via flow grinding. Additionally, adhering powder, which remains in the passage structure after the generative production process, and cross-sectional narrowings can be removed, thereby also allowing a subsequent increase in the passage diameter. The surface quality of the passage structure smoothed by means of flow grinding additionally has grinding marks oriented in the direction of flow. These afford less frictional resistance during throughflow and cannot be generated in this manner by drilling or reaming processes.

These and further advantages are explained by the following description with reference to accompanying figures. The reference to the figures in the description serves to support the description and to make it easier to understand the subject matter. The figures are merely schematic illustrations of one exemplary embodiment of the invention.

### IN THE FIGURES

FIG. 1 shows a perspective view of a side milling cutter (not according to the invention),

FIG. 2 shows a perspective view of the side milling cutter according to the invention.

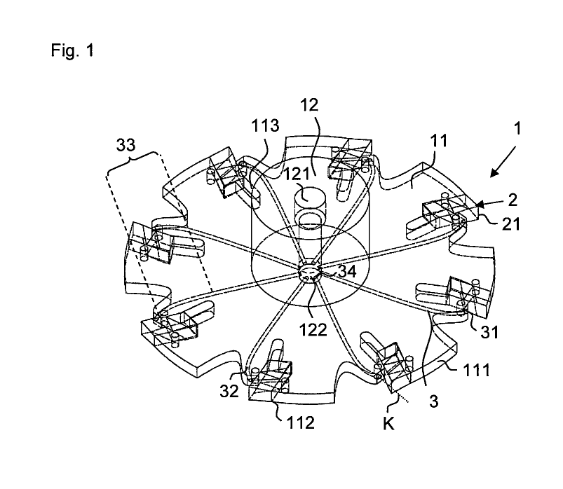

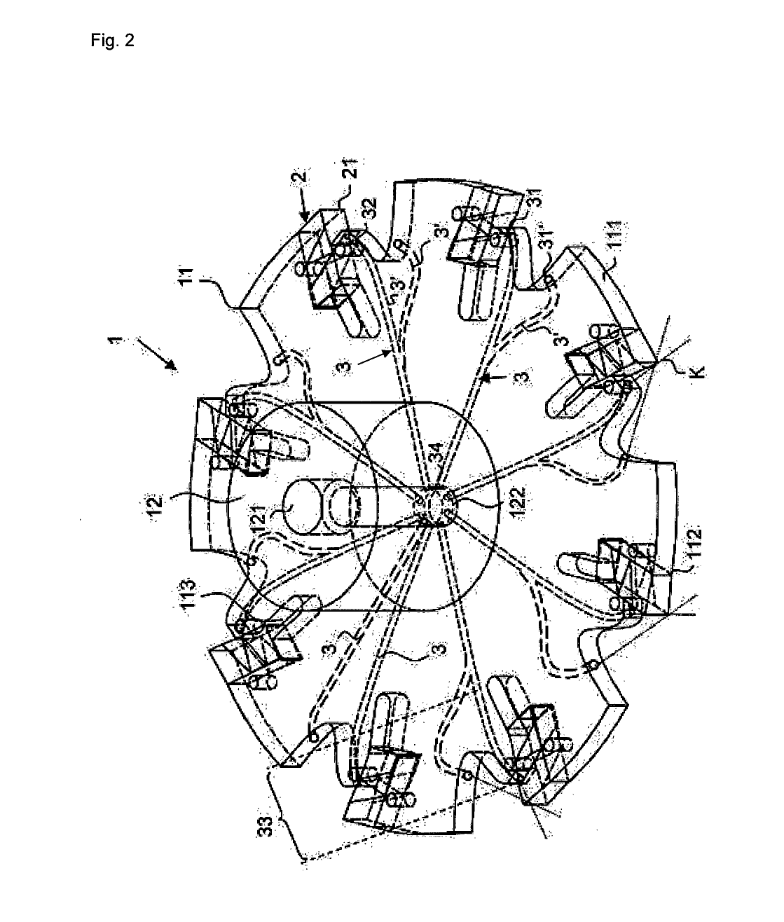

Hidden edges are shown in FIG. 1 and FIG. 2. The side milling cutter 1 has a disk body 11 and a hub 12 which are formed integrally, wherein the hub 12 is provided to be received in a milling drive and is configured as a cylinder placed coaxially on the disk body 11. Provided at regular angular spacings on the outer circumference are several cutting lips 21 which are configured as part of indexable cutting inserts 2. The indexable cutting inserts 2 are each received in an exchangeable manner in a cutting insert seat 112 which is present in the disk body 11 and the shape and dimensions of which correspond to the indexable cutting insert to be received.

A respective slot 113 extends radially inward from the cutting insert seats 112, said slots 113 being intended to provide sufficient elasticity for clamping the indexable cutting insert 2 in place. In order to create the clamping force, this not being shown in the figures, a clamping screw or the like can be provided, which exerts a clamping force on the cutting insert seat 112. The “closed end” of the slot 113 is rounded, whereby the notch effect at the slot end is intended to be reduced.

Inside the disk body 11, internal cooling lubricant passages 3, which extend in a star-shaped manner away from the hub 12, extend to each of the cutting lips 21. In the region of the cutting lips 21, the cooling lubricant passages 3 each emerge from the lateral face 111 of the disk body 11. The outlet opening 31, or the course of the cooling lubricant passage 3 at the outlet 31, is selected in this case such that a cooling lubricant jet K can be directed onto the cutting lip 21. To this end, the cooling lubricant passage 3 emerges obliquely from the surface of the disk body 11, this being achieved by the curve 32 which is arranged in the end portion 33 close to the cutting lips 21.

FIG. 2 shows the solution according to the invention, in which two cooling lubricant passages 3 extend to each cutting lip 21. It is possible according to the invention, but not shown, for there to be more thereof. Thus, the cutting lip 21 is cooled from several sides and from different angles. To this end, in one alternative, the cooling lubricant passages 3 have branches from which two or more subpassages 3′ proceed, which lead into the respective outlet openings 31, 31′. These outlet openings 31, 31′ make it possible to apply a cooling lubricant jet K to the cutting lip 21 from different directions, i.e. at a particular angular offset. Provision can even be made for the other outlet opening 31′ to be present on an opposite side of the cutting insert seat 112 from the cutting insert 2. The branch of the cooling lubricant passage K can in this case be located close to the outlet openings 31, 31′ or closer to the hub 12.

However, it is not absolutely necessary for the two outlet openings 31, 31′ to be supplied by a passage branch, rather, in another alternative, an independent cooling lubricant passage 3 can also extend in each case to the feed openings 122 or into the groove 34, this also being shown in FIG. 2. With regard to the passage design, FIG. 2 indicates several possible embodiments in a single side milling cutter 1 here—in an actual side milling cutter 1, only one possible design is selected for all the passage configurations leading to the cutting inserts 21 for economical production. Thus, FIG. 2 shows several possibilities for the passage configuration only be way of example here.

The cooling lubricant passages 3 are supplied with cooling lubricant in that they extend as far as an inner face 121 of the hub 12 and emerge from the surface there in feed openings 122, which are in turn connected to a cooling lubricant source. Via the hub 12, the side milling cutter 1 is also connected to the milling drive, such that, via a driveshaft introduced into the hub 12, the cooling lubricant can also be fed without problems. In this case, it is also possible for all the feed openings 122 of the side milling cutter 1 to be supplied from a cooling lubricant opening in the driveshaft, wherein, to this end, the encircling groove 34 is provided, as it were as a distributor. The region around the groove 34 can be sealed via O-rings.

The side milling cutter 1 according to the invention is produced via a generative production method, since it cannot be obtained by conventional casting and cutting production methods, this being in particular on account of the fine curved passage structure and comparatively small thickness of the disk body. For production, use can be made for example of selective laser melting, whereby the disk body can be produced together with the hub with little mechanical reworking. The device for selective laser melting can be removed as it were from the finished side milling cutter 1, and all that is still necessary is to insert the indexable cutting inserts 2 and to clean off residual pulverulent starting material.

What is claimed is:

1-15. (canceled)

16. A generatively produced side milling cutter (1), comprising:
a disk body (11) comprising a central hub (12) to be received in a milling drive and further comprising a plurality of cutting lips (21) on an outer circumference of the disk body (11), the disk body (11) further comprising a plurality of internal cooling lubricant passages (3) extending through the disk body (11);
each of the cooling lubricant passages (3) having at least two outlet openings (31, 31′) in the region of each cutting lip (21);
the at least two outlet openings (31, 31′) arranged such that in each case one cooling lubricant jet (K), which emerges from the cooling lubricant passage (3), is able to be directed onto the cutting lip (21);
the at least two outlet openings (31, 31′) configured to direct the cooling lubricant jets (K) onto the cutting lip (21) with a predetermined angular offset in order to support the transporting away of chips and to cool the disk body (11);
wherein at least one of the cooling lubricant jets (K) is directed at a chip detachment zone of the cutting lip (21) during operation.

17. The side milling cutter (1) as claimed in claim 16, wherein the at least two outlet openings (31, 31′) are configured to direct one cooling lubricant jet (K), respectively, onto the cutting lip (21) from different sides or from opposite directions.

18. The side milling cutter (1) as claimed in claim 16, wherein at least one of the outlet openings (31, 31′) comprises a nozzle.

19. The side milling cutter (1) as claimed in claim 18, wherein the nozzle is inserted into the at least one outlet opening (31, 31′).

20. The side milling cutter (1) as claimed in claim 18, wherein the nozzle is an angularly adjustable nozzle.

21. The side milling cutter (1) as claimed in claim 16, wherein the disk body (11) has a thickness in the range from 1 mm to 20 mm

22. The side milling cutter (1) as claimed in claim 21, wherein the thickness is in a range from 2 mm to 12 mm.

23. The side milling cutter (1) as claimed in claim 16, wherein the internal cooling lubricant passages (3) extend in a star shape away from the hub (12).

24. The side milling cutter (1) as claimed in claim 16, wherein the internal cooling lubricant passages (3) emerge from a lateral face (111) of the disk body (11).

25. The side milling cutter (1) as claimed in claim 16, wherein the internal cooling lubricant passages (3) emerge obliquely from a surface of the disk body (11).

26. The side milling cutter (1) as claimed in claim 16, wherein the internal cooling lubricant passages (3) have at least one deviation (32) that is preferably arranged in an end portion (33) close to the outlet opening (31) and is preferably rounded or curved.

27. The side milling cutter (1) as claimed in claim 16, wherein the cooling lubricant passages (3) have a feed opening (34) for cooling lubricant at an inner face of the hub (12) or at a disk face, wherein the feed opening (34) is fluidically connectable to a cooling lubricant source, wherein the cooling lubricant passages (3) each extend from the feed opening (34) to the outlet opening (31).

28. The side milling cutter (1) as claimed in claim 27, wherein an encircling groove (122) is present on the inner face (121) of the hub (12), the cooling lubricant passages (3) leading into the encircling groove (122), wherein the encircling groove (122) forms a sealable coupling portion for fluidically connecting to the cooling lubricant source.

29. The side milling cutter (1) as claimed in claim 16, wherein the cutting lips (21) are exchangeable cutting inserts (2), wherein the disk body (11) comprises cutting insert seats (112) on the outer circumference of the disk body (11), wherein the exchangeable cutting inserts (2) are arranged in the cutting insert seats (112).

30. The side milling cutter (1) as claimed in claim 29, wherein the cutting insert seats (112) each comprise a slot (113) extending radially inward in the disk body and configured to provide damping elasticity.

31. A method for producing a side milling cutter (1) as claimed in claim 16, using a generative production device, comprising the steps of:
a) loading a 3D volume data set, which describes at least the disk body (11) with the central hub (12) of the side milling cutter (1), into the generative production device,
b) providing a pulverulent starting material,
c) progressively generating material cohesion of the pulverulent starting material, including progressively producing the disk body (11) comprising the plurality of internal cooling lubricant passages (3), including at least two outlet openings (31, 31′) in the region of each cutting lip (21), and comprising the central hub (12), and
d) subsequently internally smoothing the cooling lubricant passages (3) by flow grinding.

32. The method as claimed in claim 31, further comprising melting the pulverulent starting material in step c).

33. The method as claimed in claim 31, wherein the pulverulent starting material is a metal powder.

34. The method as claimed in claim 31, wherein the generative production device is a device for selective laser melting, selective laser sintering or laser build-up welding.
